(19) United States
(12) Patent Application Publication
(10) Pub. No.: US 2026/0021007 A1
(43) Pub. Date: Jan. 22, 2026

(54) DRINK CARRIER APPARATUS

(71) Applicant: Joshua Lane Yocum, Idaho Falls, ID (US)

(72) Inventor: Joshua Lane Yocum, Idaho Falls, ID (US)

(21) Appl. No.: 19/256,266

(22) Filed: Jul. 1, 2025

Related U.S. Application Data
(60) Provisional application No. 63/673,407, filed on Jul. 19, 2024.

(51) Int. Cl. A61H 3/02; A61H 3/00

(52) U.S. Cl. CPC A61H 3/02; A61H 2003/002

(57) ABSTRACT

A drink carrier apparatus includes a frame, a first coupler member, a second coupler member, and fasteners. The frame may include a rear section, a bottom section, a front section, and an upper section. The upper section may be curved outward away from a receiving portion. The receiving portion is configured to receive a bottle. The first coupler member may be fastened to an outer surface of the rear section. The first coupler member may include a first aperture and a second aperture. The first and second apertures may be configured to receive the fasteners. The first and second apertures are spaced so as to match prefabricated apertures on, for example, crutches.

### CROSS-REFERENCE TO RELATED APPLICATIONS

This application claims the benefit of U.S. Provisional Application Ser. No. 63/673,407, filed on Jul. 19, 2024, which is incorporated herein by reference.

### TECHNICAL FIELD

The present disclosure relates to a drink holder. More particularly, the present disclosure relates to a drink holder that is coupleable to crutches, walkers, wheelchairs, or other impairment assistance devices.

### BACKGROUND

Crutches have been around for hundreds of years as a means for impaired individuals to move around. Throughout the years crutches have evolved from simple sticks to height-adjustable metal crutches. Other devices to help those who have impaired legs, feet etc. may include walkers and scooters. When an individual is using crutches or a walker, his or her hands are occupied on the handles of the walker or crutches. This prevents a user from carrying items, such as purses and drinks, in a hand. If attempts are made to carry such items, additional injury may occur if the individual were to fall.

To address this issue, the individual may carry a purse, backpack, or some other type of tote with a shoulder strap. However, when the individual is forced to use a tote, the tote may cause the individual to have balance issues when moving on crutches or a walker. It may also be uncomfortable to carry such an item, and the item may not be immediately accessible to a user. Individuals may also seek assistance from others to carry their items, but this means that there would always have to be an individual present to carry the items. Further, other attempts have been made to add carriers and cup holders to crutches and walkers; however, these carriers are often made of materials that lack durability and lack adjustability.

Accordingly, there is a need for a carrier that is easy to use and couples to crutches, walkers, and wheelchairs and that allows a user to carry essential items, such as bottles, cups, and mugs. The present invention seeks to solve these and other problems.

### SUMMARY OF EXAMPLE EMBODIMENTS

In one embodiment, a drink carrier apparatus includes a frame, a first coupler member, a second coupler member, and fasteners. The frame may include a rear section, a bottom section, a front section, and an upper section. The rear section may include a first rod and a second rod. The bottom section may be at a substantially 90-degree angle from the first and second rods. The bottom section may include a third rod and a fourth rod that continue from the first and second rods. As the third and fourth rods move away from the rear section towards the front section, a first gap between the third and fourth rods may widen. The front section may curve upward from the bottom section. The front section may include a fifth rod and a sixth rod. As the fifth and sixth rods move upward from the bottom section towards the upper section, a second gap between the fifth and sixth rods may widen. The front section may then couple to the upper section. The upper section may include a seventh rod that is perpendicular and couples to the front section. The upper section may be curved outward away from a receiving portion. The receiving portion being configured to receive a bottle.

The first coupler member may be fastened to an outer surface of the rear section. The first coupler member fastens to the first rod and the second rod, thereby securing the first and second rods and adding stability thereto. The first coupler member may be substantially flat on a first side. The first coupler member may be coupled to the first and second rods via a first groove and a second groove. The first coupler member may be generally rectangular and comprise a first aperture and a second aperture. The first and second apertures may be configured to receive a first fastener and a second fastener. The first and second apertures are spaced so as to mirror prefabricated apertures on, for example, crutches. This means that the drink carrier apparatus may be adjustable vertically on the side of a crutch so as to be customizable for a user.

### BRIEF DESCRIPTION OF THE DRAWINGS

FIG. 1 illustrates a rear-side perspective view of a drink carrier apparatus;

FIG. 2 illustrates a left-side perspective view of a drink carrier apparatus;

FIG. 3 illustrates a right-side perspective view of a drink carrier apparatus;

FIG. 4 illustrates a front perspective view of a drink carrier apparatus;

FIG. 5 illustrates a rear perspective view of a drink carrier apparatus;

FIG. 6 illustrates a rear perspective view of a first coupler member of a drink carrier apparatus;

FIG. 7 illustrates a bottom perspective view of a first coupler member of a drink carrier apparatus;

FIG. 8 illustrates a perspective view of a drink carrier apparatus coupled to a crutch;

FIG. 9 illustrates a top perspective view of a second coupler member of a drink carrier apparatus;

FIG. 10 illustrates a top perspective view of a second unit of a second coupler member of a drink carrier apparatus;

FIG. 11 illustrates a left-side perspective view of a drink carrier apparatus with a second coupler member;

FIG. 12 illustrates a rear perspective view of a drink carrier apparatus with a second coupler member; and

FIG. 13 illustrates a side perspective view of a drink carrier apparatus with a second coupler member affixed to a walker.

### DETAILED DESCRIPTION OF EXAMPLE EMBODIMENTS

While embodiments of the present disclosure may be subject to various modifications and alternative forms, specific embodiments have been shown by way of example in the drawings and will be described in detail herein. However, the present disclosure is not intended to be limited to the particular features, forms, components, etc. disclosed. Rather, the present disclosure will cover all modifications, equivalents, and alternatives falling within the scope of the present disclosure.

Reference to the invention, the present disclosure, or the like are not intended to restrict or limit the invention, the present disclosure, or the like to exact features or steps of any one or more of the exemplary embodiments disclosed herein. References to “one embodiment,” “an embodiment,” “alternate embodiments,” “some embodiments,” and the like, may indicate that the embodiment(s) so described may include a particular feature, structure, or characteristic, but not every embodiment necessarily includes the particular feature, structure, or characteristic.

Any arrangements herein are meant to be illustrative and do not limit the invention's scope. Although specific terms are employed herein, they are used in a generic and descriptive sense only and not for purposes of limitation. Unless otherwise defined herein, such terms are intended to be given their ordinary meaning not inconsistent with that applicable in the relevant industry and without restriction to any specific embodiment hereinafter described. Certain terms are used herein, such as “comprising” and “including,” and similar terms are meant to be “open” and not “closed” terms.

It will be understood that the steps of any such processes or methods are not limited to being carried out in any particular sequence, arrangement, or with any particular graphics or interface. In fact, the steps of the disclosed processes or methods generally may be carried out in various, different sequences and arrangements while still being in the scope of the present invention.

As previously described, there is a need for a carrier that is easy to use and couples to crutches, walkers, and wheelchairs and that allows a user to carry essential items, such as bottles, cups, and mugs. The present invention seeks to solve these and other problems.

Crutches, walkers, and wheelchairs (i.e., impairment devices) have been important to many people for hundreds of years. These devices have given individuals with permanent or temporary disabilities the ability to move around. While these devices are extremely helpful for many, they often lack accessories or qualities that assist a user, such as carriers for bottles and other items. Attempts have been made to address these shortcomings with little to no success. Some of the approaches to address these shortcomings have included carrying a tote with a shoulder strap that is not an accessory to crutches, walkers, and wheelchairs; creating accessories for carrying items, like large baskets where items may fall out; and having someone tag along to carry the items. All of these approaches create further issues and fail to address the need of carrying items for the individual.

The drink carrier apparatus described herein includes a frame, a first member coupler, a second member coupler, and one or more fasteners, the drink carrier apparatus capable of coupling to an impairment device. It will be appreciated that the apparatus allows a user the ability to carry any type of bottle while utilizing the impairment device. It will further be appreciated that the drink carrier is slim and lightweight so as to not create any sort of movement issues with the impairment device.

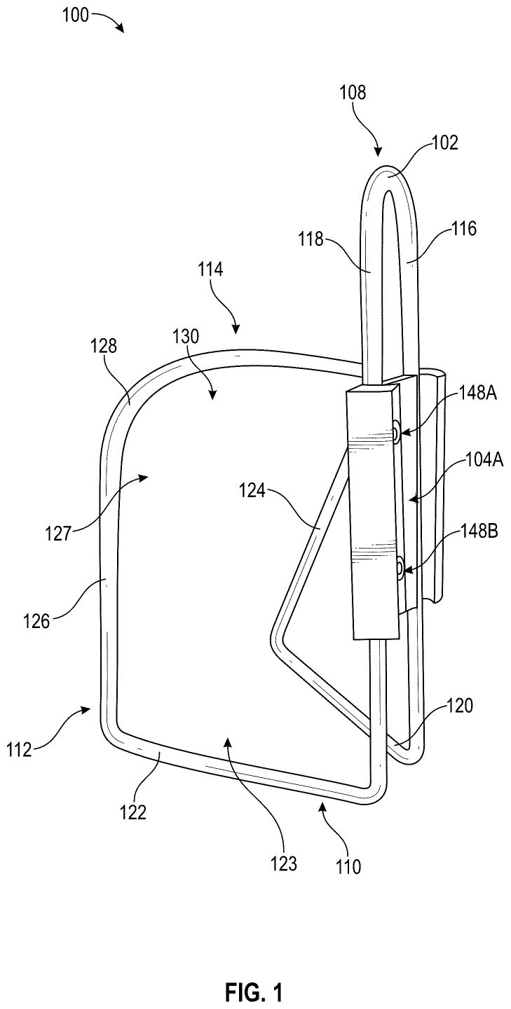

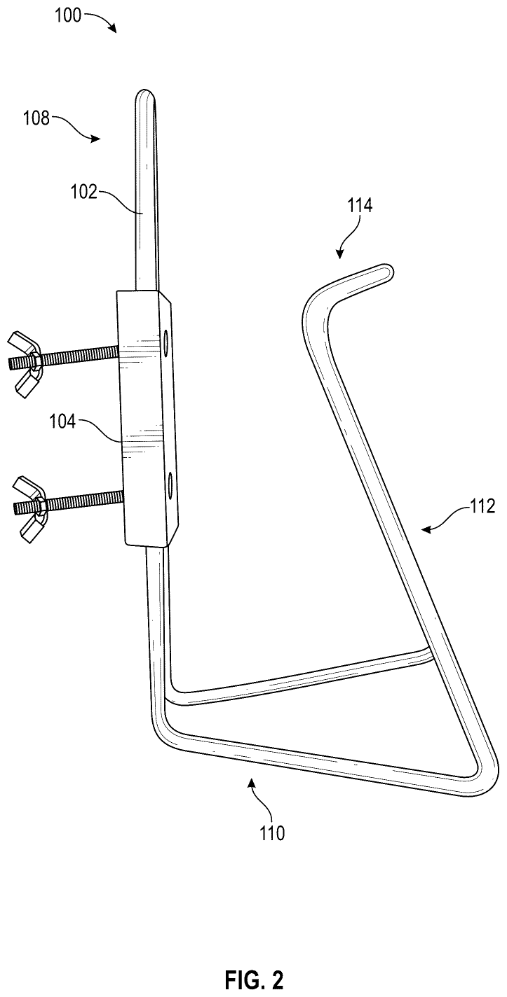

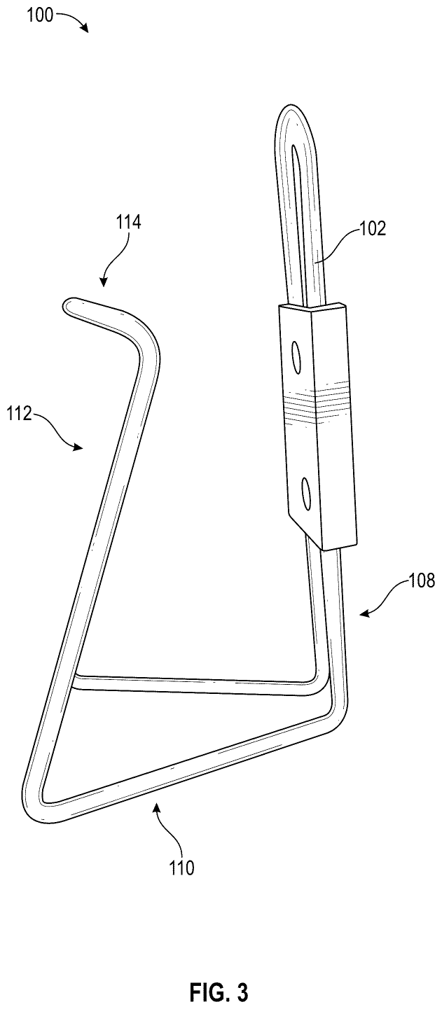

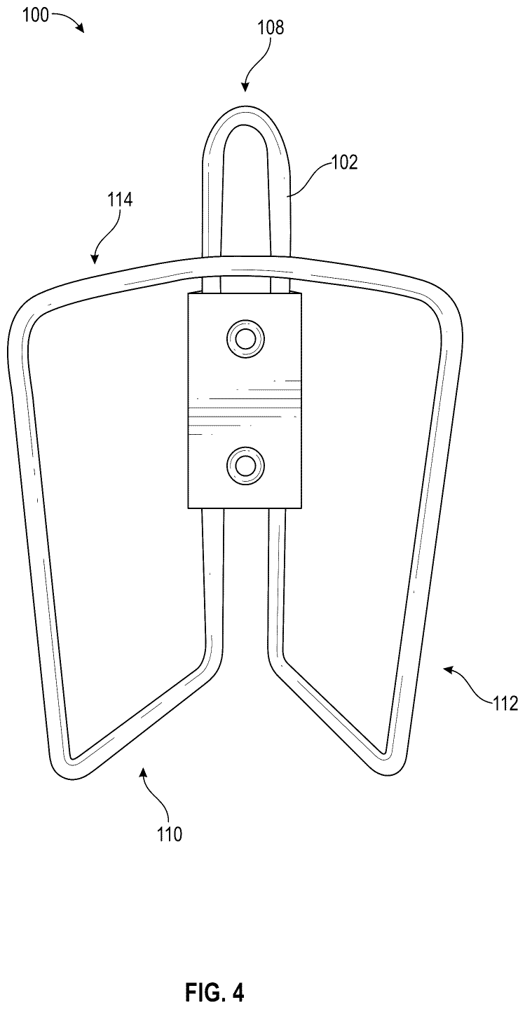

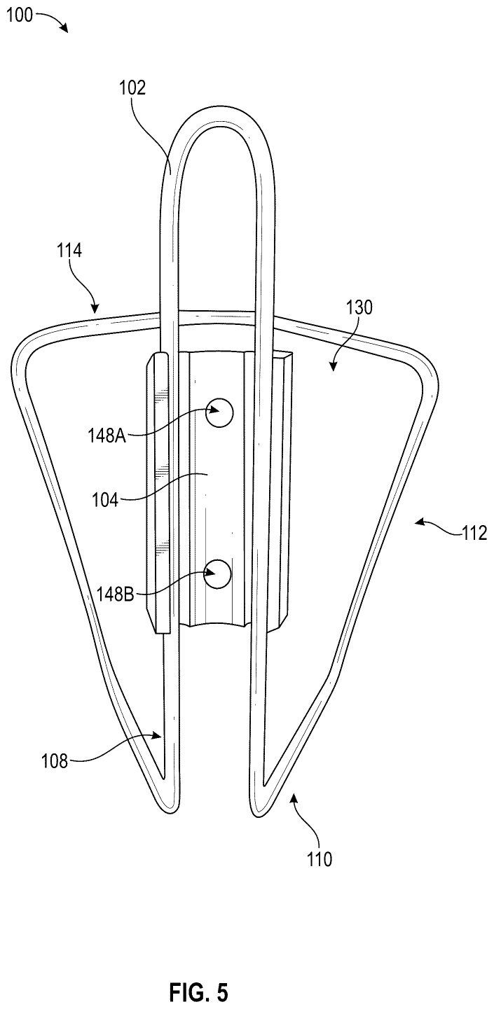

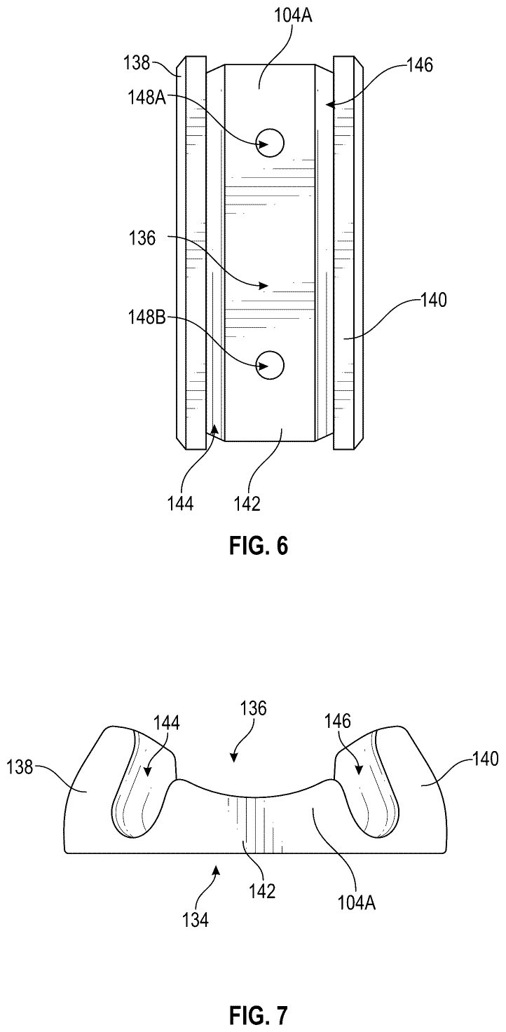

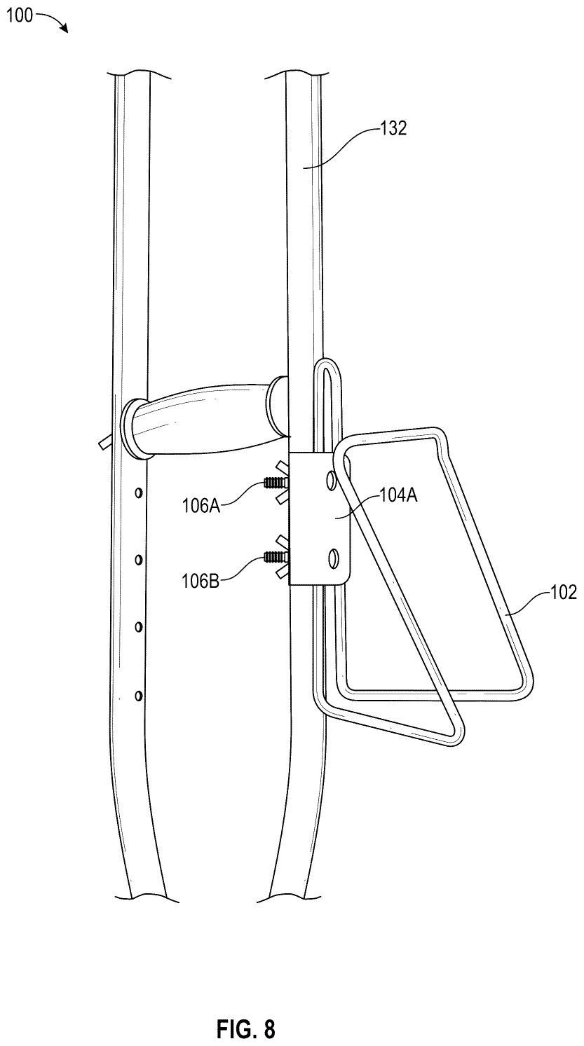

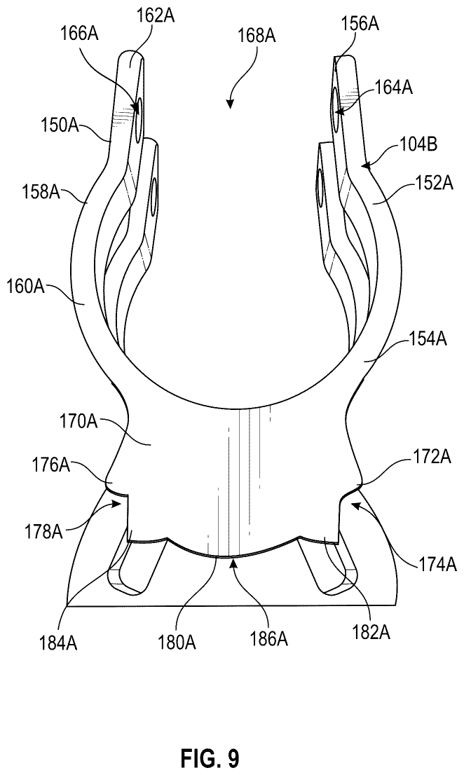

As shown in FIGS. 1-8, in one embodiment, a drink carrier apparatus 100 includes a frame 102, a first coupler member 104A and a second coupler member 104B (FIG. 9) that is configured to interface with the first coupler member 104A, and fasteners 106A, 106B. The frame 102 may include a rear section 108, a bottom section 110, a front section 112, and an upper section 114. The rear section 108 may include a first rod 116 and a second rod 118, both being formed from a single piece of material and creating a continuous loop at an upper portion thereof. In some embodiments, the first rod 116 and the second rod 118 may be separate from each other. The bottom section 110 may be at a substantially 90-degree angle from the first and second rods 116, 118. The bottom section 110 may include a third rod 120 and a fourth rod 122 that continue from the first and second rods 116, 118, or in some embodiments, the third and fourth rods 120, 122 may be separate components from the first and second rods 116, 118. As the third and fourth rods 120, 122 move away from the rear section 108 towards the front section 112, a first gap 123 between the third and fourth rods 120, 122 may widen. The front section 112 may curve upward from the bottom section 110 at substantially a 60-degree angle; however, it will be appreciated that the front section 112 may be at a variety of angles in relationship to the bottom section 110 so as to accommodate numerous sizes and shapes of bottles. The front section 112 may include a fifth rod 124 and a sixth rod 126. As the fifth and sixth rods 124, 126 move upward from the bottom section 110 towards the upper section 114, a second gap 127 between the fifth and sixth rods 124, 126 may widen. The front section 112 may then couple to the upper section 114. The upper section 114 may include a seventh rod 128 that is perpendicular to and couples to the front section 112, more particularly, the fifth and sixth rods 124, 126. The upper section 114 may be curved outward away from a receiving portion 130, or may, in some embodiments, be generally straight. The receiving portion 130 may be configured to receive a bottle. The receiving portion 130 may be configured to hold large drink carriers, fountain drinks, and other items with, for example, a circular or non-circular design.

The front section 112 may be flexible, thereby capable of extending outward to accommodate larger bottle sizes. As such, the flexibility of the front section 112 may assist in retaining a bottle in the receiving portion 130. In some embodiments, the frame 102 may be manufactured from a flexible material or a non-flexible material. In other embodiments, portions of the frame 102 may be manufactured from flexible and non-flexible material.

While the frame 102 is shown as being continuous with a single connection point, it will be appreciated that the frame may be divided into various removably attachable components. The frame 102 may be made of 4 mm, 5 mm, or any other diameter of rod. The frame 102 may also be made from square-shaped tubing or any other shape of tubing. The frame 102 may be manufactured from aluminum. Other embodiments may include a frame 102 that is manufactured from steel, fiberglass, carbon fiber, plastic or any other material known in the art. Due to the aluminum frame, the drink carrier apparatus 100 has increased tensile strength as compared to plastic. The greater tensile strength is configured to accommodate various drink sizes and weights.

On an outer surface, the surface that interacts with the impairment device, of the rear section 108, the first coupler member 104A may be fastened. The first coupler member 104A may include a first side 134 that is generally flat and faces the front section 112 when coupled to the frame 102. The first coupler member 104A may include a second side 136. The second side 136 may include a first angled wall 138, a second angled wall 140 on a side opposite the first angled wall 138, and a plateau 142 interposed between the first angled wall 138 and the second angled wall 140. The first and second angled walls 138, 140 may be angled inward toward a center of the second side 136. The plateau 142 may be dished from a top to a bottom of the first coupler member 104A. It will be appreciated that the dished portion of the plateau 142 may be configured to receive or mate with tubing, such as tubing on a crutch. Positioned between the first angled wall 138 and the plateau 142 may be a first groove 144 that runs the length of the first coupler member 104A and has portions that are formed by the first angled wall 138 and the plateau 142. Similarly, positioned between the second angled wall 140 and the plateau 142 may be a second groove 146 that runs the length of the first coupler member 104A and has portions that are formed by the second angled wall 140 and the plateau 142. The first and second grooves 144, 146 may be configured to snap onto the first rod 116 and the second rod 118 and/or may be adhered to the surfaces of the first and second grooves 144, 146. In some embodiments, the first coupler member 104A may be a plate that fastens to the rear section 108. The first coupler member 104A may be manufactured from aluminum, steel, plastic, etc. In some embodiments, the drink carrier apparatus 100 may include a first plate and a second plate spaced apart to correspond to prefabricated apertures on crutches. The first coupler member 104A couples to the first rod 116 and the second rod 118, thereby securing the first and second rods 116, 118 and adding stability thereto. The first coupler member 104A may be substantially flat; however, in some embodiments, the first coupler member 104A may be curved in its entirety. In some embodiments, as discussed above, the first coupler member 104A may be coupled to the first and second rods 116, 118 via an adhesive or other chemical means. In some embodiments, the first coupler member 104A may be coupled to the first and second rods 116, 118 via clamps, crimping, or another mechanical coupling mechanism. Furthermore, the first coupler member 104A may be generally rectangular and comprise a first aperture 148A and a second aperture 148B. While two apertures are shown, the first coupler member 104, in some embodiments, may include one or more than two apertures. The first and second apertures 148A, 148B may be spaced apart 1.5 inches, or in other embodiments, the first and second apertures 148A, 148B may be spaced apart 3 inches. The first and second apertures 148A, 148B may be countersunk and be configured to receive the first fastener 106A and the second fastener 106B. The first and second fasteners 106A, 106B may both be bolts and wing nuts. In some embodiments, the first and second fasteners 106A, 106B may be screws, straps, clamps, magnets, or any other coupling device. It will be appreciated that the first coupler member 104 with the first and second fasteners 106A, 106B interacts with and couples to the impairment device 132 (e.g., crutch or walker). The first and second apertures 148A, 148B are spaced so as to mirror prefabricated apertures on, for example, crutches and receive the first and second fasteners 106A, 106B. This means that the drink carrier apparatus 100 may be adjustable vertically on the side of a crutch so as to be customizable for a user.

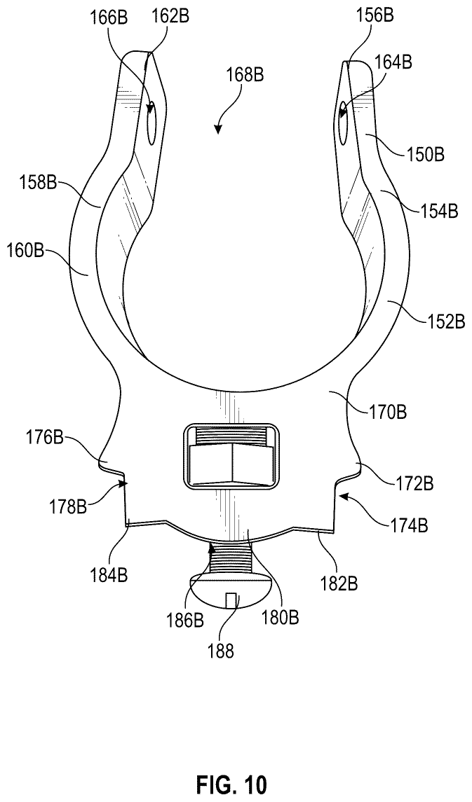

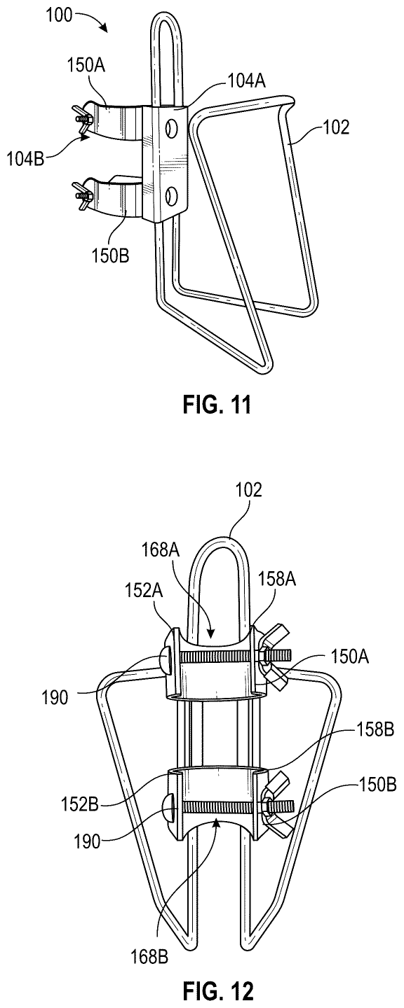

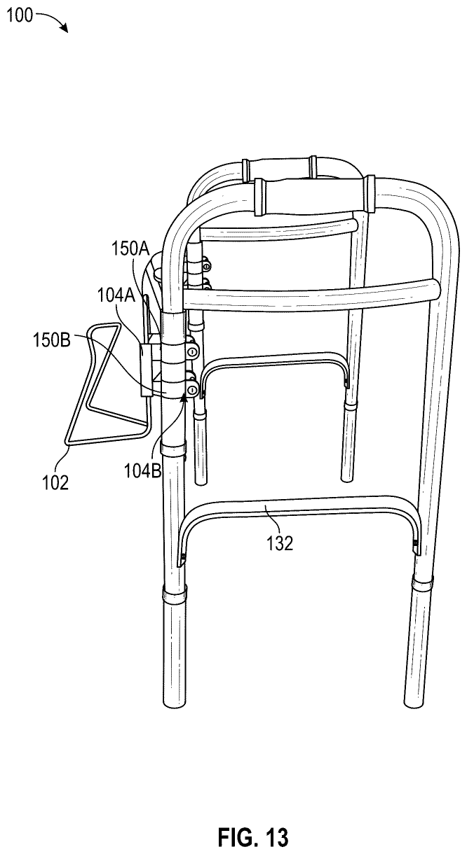

As shown in FIGS. 9-13, the second coupler member 104B may include a first unit 150A and a second unit 150B. The first and second units 150A, 150B may mirror each other and may be interchangeable. The first and second units 150A, 150B may each include a first arm 152A, 152B with a first curved section 154A, 154B and a first finger 156A, 156B extending from the first curved section 154A, 154B, a second arm 158A, 158B with a second curved section 160A, 160B and a second finger 162A, 162B extending from the second curved section 160A, 160B. The first and second fingers 156A, 156B, 162A, 162B may include a first finger aperture 164A, 164B and a second finger aperture 166A, 166B, respectively. The first and second arms 152A, 152B, 158A, 158B may be spaced apart so as to create a channel 168A, 168B. The first and second arms 152A, 152B, 158A, 158B may extend from a base 170A, 170B. The base 170A, 170B may include a first protrusion 172A, 172B and a first recessed portion 174A, 174B positioned beneath the first protrusion 172A, 172B and a second protrusion 176A, 176B and a second recessed portion 178A, 178B positioned beneath the second protrusion 176A, 176B. A side of the base 170A, 170B distal from the channel 168A, 168B may include a radiused section 180A, 180B with a first wing 182A, 182B and a second wing 184A, 184B. It will be understood that the first and second protrusions 172A, 172B, 176A, 176B may rest on edges of the first and second angled walls 140, 142 and the radiused section 180A, 180B may rest in the dished portion of the plateau 144. The first and second wings 182A, 182B, 184A, 184B may rest over the openings to the first and second grooves 144, 146. Accordingly, as the second coupler member 104B is attached to the first coupler member 104A, the first and second rods 116 and 118 are secured between both the first and second coupler members 104A, 104B. Fasteners may be placed through the first and second apertures 148A, 148B on the first coupler member 104A and couple to receiving apertures 186A, 186B on the first and second units 150A, 150B. As such, the receiving apertures 186A, 186B may be threaded or include a nut so as to receive a coupler 188. The apertures 164A, 164B, 166A, 166B on the first and second fingers 156A, 156B, 162A, 162B may be configured to receive fasteners 190, thereby allowing the channel 168A, 168B to narrow or widen based on the fasteners' 190 position. As such, the first and second arms 152A, 152B, 158A, 158B may be positioned around a tube and coupled thereto as the fasteners are tightened or engaged. While two units are shown, it will be appreciated that more or less than two may be used without departing herefrom. The second coupler member 104B may be used with walkers, or in some embodiments, crutches, scooters, etc.

In other embodiments, the drink carrier apparatus 100 may include clamps, sliding mechanisms, straps, or another form of securement mechanism to couple the drink carrier apparatus 100 to the impairment device 132. For example, a clasp style coupling device may directly couple to the first and second rods without use of a rectangular bar or plate.

In some embodiments, the drink carrier apparatus 100 may have indicia (e.g., color coding) to determine the size of the apparatus. For example, a first size may be blue, while a second size that is smaller than the first size may be red. The various sizes of drink carrier apparatuses may be configured to receive any number of bottles having different heights and circumferences.

The drink carrier apparatus 100 functions by placing a drink container or similar item between the front section 112 and the rear section 108 and resting on the bottom section 110. A user may benefit from the drink carrier apparatus 100 by being able to transport a drink on the impairment device 132 while having both hands free. The drink carrier apparatus 100 is easy to install, adjust, and use.

It will be understood that while various embodiments have been disclosed herein, other embodiments are contemplated. Further, certain embodiments of the present disclosure may include, incorporate, or otherwise comprise properties or features described in other embodiments. Consequently, various features of certain embodiments can be compatible with, combined with, included in, and/or incorporated into other embodiments of the present disclosure. Therefore, disclosure of certain features or components relative to a specific embodiment of the present disclosure should not be construed as limiting the application or inclusion of said features or components to the specific embodiment unless stated. As such, other embodiments can also include said features, components, members, elements, parts, and/or portions without necessarily departing from the scope of the present disclosure. The embodiments described herein are examples of the present disclosure. Accordingly, unless a feature or component is described as requiring another feature or component in combination therewith, any feature herein may be combined with any other feature of a same or different embodiment disclosed herein. Although only a few of the example embodiments have been described in detail herein, those skilled in the art will appreciate that modifications are possible without materially departing from the present disclosure described herein. Accordingly, all modifications may be included within the scope of this invention.

What is claimed is:

1. A drink carrier apparatus comprising:
a frame comprising a rear section, a bottom section, a front section, an upper section, and a receiving portion that receives bottles;
a first coupler member removably attachable to the rear section of the frame; and
fasteners that couple the frame to an impairment device.

2. The drink carrier apparatus of claim 1, wherein the rear section comprises a first rod and a second rod both being formed from a single piece of material and creating a continuous loop at an upper portion thereof.

3. The drink carrier apparatus of claim 1, wherein the bottom section comprises a third rod and a fourth rod.

4. The drink carrier apparatus of claim 1, wherein the front section comprises a fifth rod and a sixth rod.

5. The drink carrier apparatus of claim 1, wherein the upper section comprises a seventh rod.

6. The drink carrier apparatus of claim 1, wherein the front section is flexible.

7. The drink carrier apparatus of claim 1, wherein the bottom section is at a substantially 90-degree angle from the rear section.

8. The drink carrier apparatus of claim 3, wherein a first gap is positioned between the third rod and the fourth rod.

9. The drink carrier apparatus of claim 8, wherein the first gap widens as the third rod and the fourth rod move from the rear section towards the front section.

10. The drink carrier apparatus of claim 1, wherein the front section curves upward from the bottom section.

11. The drink carrier apparatus of claim 4, wherein a second gap is positioned between the fifth rod and the sixth rod.

12. The drink carrier apparatus of claim 11, wherein the second gap widens as the fifth rod and the sixth rod move upward from the bottom section to the upper section.

13. The drink carrier apparatus of claim 1, further comprising a second coupler member that is removably attachable to the first coupler member.

14. The drink carrier apparatus of claim 1, wherein the frame comprises a continuous, single piece of material.

15. The drink carrier apparatus of claim 1, wherein the frame is aluminum, steel, or plastic.

16. A drink carrier apparatus comprising:
a frame comprising a receiving portion that receives bottles;
a first coupler member removably attachable to the frame, the first coupler comprising:
a first side;
a second side comprising a first angled wall, a second angled wall on a side opposite the first angled wall, and a plateau interposed between the first angled wall and the second angled wall; and
a first aperture and a second aperture;
fasteners that pass through the first aperture and second aperture and an impairment device.

17. The drink carrier apparatus of claim 16, wherein the first coupler comprises a first groove positioned between the first angled wall and the plateau that receives the frame.

18. The drink carrier apparatus of claim 16, wherein the first coupler comprises a second groove positioned between the second angled wall and the plateau that receives the frame.

19. The drink carrier apparatus of claim 16, further comprising a second coupler member that includes one or more units that are removably attachable to the first coupler member.

20. A drink carrier apparatus comprising:
a frame comprising a receiving portion that receives bottles;
a first coupler member removably attachable to the frame, the first coupler comprising:
a first side;
a second side comprising a first angled wall, a second angled wall on a side opposite the first angled wall, and a plateau interposed between the first angled wall and the second angled wall; and
a first aperture and a second aperture;
a second coupler member comprising a first unit and a second unit, the first and second units comprising:
a base,
first and second arms extending from the base,
wherein the base mates with the second side of the first coupler member;
fasteners that pass through the first aperture and second aperture and an impairment device.
